(19) United States
(12) Patent Application Publication
(10) Pub. No.: US 2005/0066032 A1
(43) Pub. Date: Mar. 24, 2005

(54) Capacity on demand grace period for incompliant system configurations

(75) Inventors: Daniel C. Birkestrand, Rochester, MN (US); Randall L. Grimm, Rochester, MN (US); David O. Lewis, Rochester, MN (US); Terry L. Schardt, Oronoco, MN (US)

Correspondence Address: Grant A. Johnson;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/650,541

(22) Filed: Aug. 28, 2003

(51) Int. Cl. G06F 15/173

(52) U.S. Cl. 709/225

(57) ABSTRACT

Method, apparatus and article of manufacture for allowing a time-limited use of on-demand resources. The method comprises initiating a grace period upon determining a predefined state of the computerized system hosting the on-demand resources. During the grace period, the on-demand resources may be used by a function(s). In one embodiment, the on-demand resources are made unavailable to the function(s) upon expiration of the grace period. In another embodiment, the grace period is terminated upon the occurrence a predefined event. For example, one predefined event may be the placement of the computerized system in a compliant state with respect to the on-demand resources.

### CROSS-REFERENCE TO RELATED APPLICATIONS

This application is related to co-pending and commonly owned U.S. patent application Ser. No. 10/406,652, entitled “METHOD TO PROVIDE ON-DEMAND RESOURCE ACCESS” and U.S. patent application Ser. No. 10/422,663, entitled “METHOD TO ENSURE A UNIQUE MACHINE SERIAL NUMBER”, herein incorporated by reference in their entireties.

### BACKGROUND OF THE INVENTION

1. Field of the Invention

The present invention generally relates to data processing and more particularly to the selective enablement and disablement of hardware capacity on a computerized apparatus.

2. Description of the Related Art

The operation of a business is a dynamic undertaking. To increase profit margins, businesses continually seek out means of assessing and controlling costs. For many businesses, one attractive alternative to outright purchases of assets is leasing. Leasing provides flexibility and, in some cases, tax advantages.

Regardless of whether an asset is purchased or leased, some assets have periods of idleness, or decreased usage. During these periods, the assets are not productive, or not optimally productive, but still have associated costs that the business incurs. A particular asset that suffers from this problem is the computer.

Today's computers are powerful devices having significant capacity for functions such as processing and storage. Unfortunately, the cost of owning and operating computers can be significant for some businesses. In order to be effective, the computerized resources of a business must be sufficient to meet the current needs of the business, as well as projected needs due to growth. In addition, even assuming no growth, the resources must be capable of tolerating the business's inevitable peaks and valleys of day-to-day operations due to increased loads for seasonal, period end, or special promotions.

As a result, businesses are left in the position of having to invest in more computerized resources than they immediately need in order to accommodate growth and operational peaks and valleys. In the event the growth exceeds the available computerized resources, the business must upgrade its resources, again allowing for projected growth. Thus, at any given time in its growth cycle, a business will have excess computer capacity allowing for growth as well as the peaks and valleys of short-term operations. This excess capacity translates into real cost for the business.

One solution that gives user's more flexibility is on-demand access to computerized resources. Various forms of on-demand resource access are available from International Business Machines, Inc (IBM). For example, one form of on-demand access is provided by International Business Machines, Inc. under the name “Capacity on Demand” on its line of eServer computers. In general, Capacity on Demand may be provided on a permanent basis or a temporary basis (i.e., limited resources for limited period of time). In any case, computerized resources are made available on demand in response to actual needs, rather than projected needs. In one aspect, the provision of such flexibility provides a cost efficient solution to accommodate peaks and valleys that occur in any business. Increased loads for seasonal, period end, or special promotions, for example, can be responded to quickly and efficiently. A customer pays for the capacity/resource that is required, when it is needed. As a result, the cost of computerized resources substantially matches the computerized resources actually being used, and does not include a substantial premium for excess capacity not being used. Of course, in practice, providers may attach some form of a premium to the flexibility provided by on demand resource access. However, even with such a premium, most users will realize savings.

Conventionally, users are given access to additional capacity on systems by entering an enablement code provided by a provider, such as IBM, Inc. In one implementation, validation of the enablement code is then performed using enablement data stored on a smart chip onboard the systems. If the enablement code is validated, the user may then request the use of some quantity of resources (e.g., some number of processors). The user may be charged a fee for the usage (based on, for example, the quantity of resources used and the length of time the resources are used).

To ensure seamless operation, the state of the on-demand resources must be persistent across power outages and other rebooting of the system. Accordingly, the state of the on-demand resources is preserved on a persistent storage device. However, in some cases the state of the system may be corrupted. For example, the persistent storage device may need to be replaced due to a field failure or system upgrade. When the system reboots after the field replacement of the persistent storage device, the state of the on-demand resources will necessarily be that of the base system (before any on-demand resource activation), since the replacement persistent storage device has not yet had any on-demand resource activation recorded on it. However, other persistent system functions will continue to require the on-demand resources previously activated. The request by the system functions for on-demand resources will cause an on-demand control mechanism to flag the system as incompliant (i.e., indicate that on-demand resources that have not been activated are in use on the system). The flag will cause a defined enforcement policy of the on-demand control mechanism to be carried out, e.g., system performance is reduced, a message is issued to the operator, and system boot is prevented. As a result, the system owner experiences a substantial inconvenience because of the replacement of the persistent storage device.

A possible solution to the foregoing problem is to put all persistent resource records on the same storage device. However, different functions do not access the same devices. Another possible solution is to reclaim on-demand resources from other persistent functions when the system is rebooted following replacement of the persistent storage device. However, the persistent functions from which the resources are reclaimed may not be functional with fewer resources. Yet, another possible solution is to ship all necessary enablement codes, e.g., in printed form, with the work orders for field replacements. The solution is undesirable because each system requires unique enablement codes, and neither the user nor the manufacture may have access to all of the data needed for generation of enablement codes. For example, in one implementation, enablement codes are generated using a smart chip identification code (i.e., an ID of the chip on which state information is to be stored). However, this identification code is inaccessible to users. Still, another possible solution is to require the manufacturer to generate enablement codes when shipping the replacement persistent storage device. This is undesirable because the customer service records containing the necessary system data may not be correct for various reasons (e.g., a customer may have changed its own system serial number).

Therefore, there is a need for handling situations in an on-demand capable system where the persistent storage device used to preserve the on-demand state of the system is replaced.

### SUMMARY OF THE INVENTION

The present invention generally pertains to on-demand access to computerized resources.

One embodiment provides a computer-implemented method for providing access to on-demand resources on a computerized apparatus. The method comprises receiving an enablement code; validating the enablement code; enabling an on-demand resource, if the validating is successful; storing an enabled state of the on-demand resource; allowing a function to use the enabled on-demand resource; and in response to a change from the enabled state to a non-enabled state of the on-demand resource, initiating a grace period during which the function may continue to use the on-demand resource while in the non-enabled state.

Another embodiment of a computer-implemented method for providing access to on-demand resources on a computerized apparatus comprising enabling an on-demand resource; allowing a function to use the on-demand resource; disabling the on-demand resource; and allowing the function to continue using the on-demand resource for a limited period of time after disabling the on-demand resource, in order to give a user of the computerized apparatus an opportunity to request and receive an enablement code configured to enable the on-demand resource.

Yet, another embodiment provides a computer-implemented method for providing access to an on-demand resource on a logically partitioned computerized apparatus. The method comprises claiming, by a logical partition function, the use of the on-demand resource; recording the logical partition function's use of the on-demand resource as state information; changing the state information, whereby use of the on-demand resource by the logical partition function is made incompliant with respect to the state information; and initiating a grace period during which the logical partition function is allowed to continue using the on-demand resource for a limited period of time after changing the state information.

Yet, another embodiment provides a computer readable medium containing a program which, when executed, performs an operation for providing access to an on-demand resource on a computerized apparatus. The operation comprises recording a compliant state of the computerized apparatus, with respect to the on-demand resource, in which a system function uses the on-demand resource with authorization; determining an incompliant state, with respect to the on-demand resource, in which the system function uses the on-demand resource without authorization; and initiating a grace period during which the system function may continue to use the on-demand resource while in the incompliant state.

Still, another embodiment provides a computerized apparatus comprising on-demand resources configured to be claimed for use by a function and a capacity manager. The capacity manager is configured to enable the on-demand resources for use by the function, wherein the computerized apparatus is in a compliant state when the function only claims usage of the enabled on-demand resources and does not claim any disabled on-demand resources; and initiate a grace period during which the function may continue to use the on-demand resources while in the incompliant state for a defined period of time.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram of an environment having a provider of enablement disablement codes.

FIG. 2 is a flow diagram illustrating a possible sequence of operations which may result in the initiation of a grace period routine.

FIGS. 3 and 4 are flow diagrams illustrating one embodiment of a grace period routine.

### DETAILED DESCRIPTION OF THE PREFERRED EMBODIMENTS

The present invention generally pertains to on-demand access to computerized resources (also referred to herein as Capacity on Demand). Computerized resources are made available to users on demand. In one embodiment, for example, on-demand resource access may be made available by inputting and validating an enablement code. Once enabled, on-demand resources may be requested by various system functions. During normal operation, the state of the system is persisted on a persistent storage device. In some cases, the on-demand state of the system may become corrupted (such as where the persistent storage device is removed), in which case the continued requests for on-demand resources are flagged as a violation. To prevent an enforcement policy from being implemented to the detriment of the system owner, a grace period is automatically initiated. A grace period provides the owner a defined period of time in which to bring the system into compliance with respect to the requests for on-demand resources.

It should be noted that while aspects of the invention are described in the context of a business, the invention provides advantages to any user, whether involved in a business or not.

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

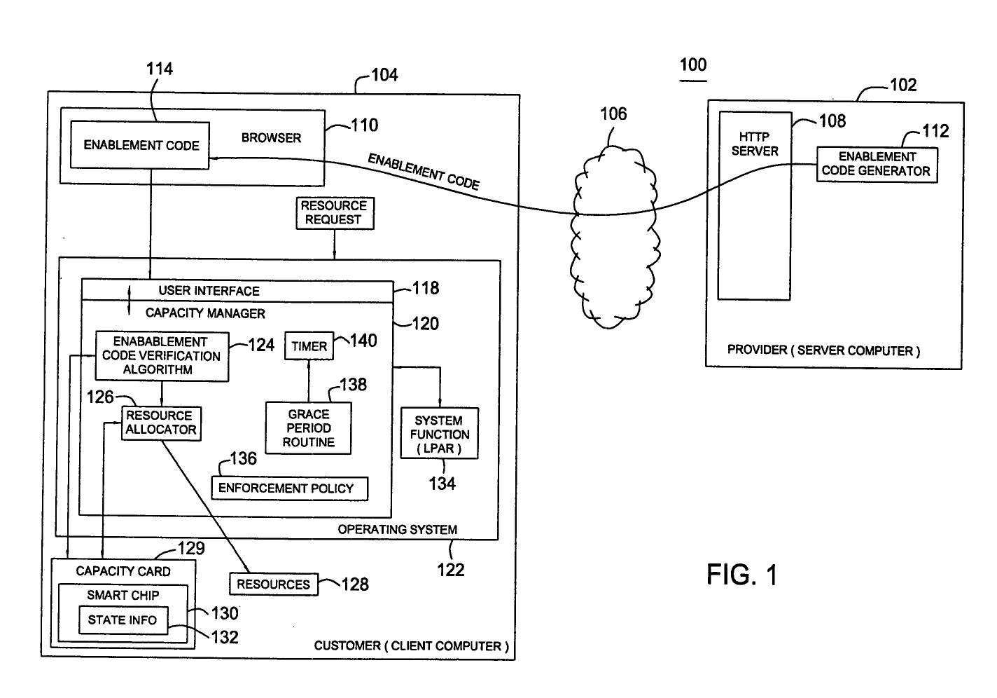

Referring now to FIG. 1, one embodiment of a data processing environment 100 is shown. Generally, the environment includes a provider computer 102 and a customer computer 104. The provider computer 102 is illustratively embodied as a server computer with respect to the customer computer 104, which is, therefore, embodied as a client computer. Although both are shown as singular entities, in practice the provider computer 102 and the client computer 104 may each be a network of computers configured to perform various functions, including those described herein. Therefore, it is understood that although only one client computer is shown, a plurality of client computers may be configured according to aspects of the invention and, in some cases, be serviced by the provider computer 102 and/or the customer computer 104. Further, the terms “client” and “server” are used merely for convenience and not by way of limitation. As such, the customer computer 104, which may be a client relative to the provider computer 102 in some regards, may itself be a server relative to one or more other clients (not shown).

The provider computer 102 and the customer computer 104 communicate through a network 106. Illustratively, the network 106 may be any medium through which information may be transferred such as, for example, a local area network (LAN) and a wide area network (WAN), or a telephone network. The network 106 is merely representative of one communications medium. Some aspects of the invention may be facilitated by other communication mediums such as, for example, the U.S. Postal Service. Still other aspects may be practiced in the absence of any communication mediums between the provider 102 and the customer 104.

In a particular embodiment, the network 106 is the Internet. As such, the provider computer 102 may be configured with a hypertext transfer protocol (HTTP) server 108 capable of servicing requests from a browser program 110 residing on the customer computer 104. The HTTP server 108 and the browser program 110 provide convenient and well-known software components for establishing a network connection (e.g., a TCP/IP connection) via the network 106, and for receiving information from users on the computer systems 102, 104.

In one embodiment, the provider computer 102 is configured with an enablement code generator 112. The code generator 112, in one embodiment, is an algorithm capable of generating enablement code 114. The code generator 112 may be invoked by a request received from the customer computer 104 via the network 106. In response to a request, the code generator 112 generates an enablement code 114, which may be returned to the customer computer 104 via the same network connection. Alternatively, the code 114 may be returned via a different network connection, e.g., a subsequent network connection or an altogether different network. In a particular embodiment, the code 114 is transmitted electronically to a client mail application (e.g., Lotus Notes® or Microsoft Outlook®; not shown) residing on the customer computer 104. Lotus Notes is a registered trademark of International Business Machines, Inc., and Microsoft Outlook is a registered trademark of Microsoft, Inc. In yet another alternative, the code 114 is provided to the user (e.g., administrator) of the customer computer 104 via paper mail (i.e., the postal service) or facsimile, for example.

Regardless of the particular medium, the code 114 may be any information that enables an on-demand resource (e.g., either permanently or temporarily). Preferably, the code 114 is unique and configured for use only on a particular machine (e.g., the customer computer 104). Uniqueness may be ensured, for example, using system information of the customer computer 104, including the machine type and serial number. Uniqueness may further be ensured by using a chip identifier (ID) for a chip on board the customer computer 104. One such chip is represented in FIG. 1 as a smart chip 130 on board a capacity card 129. A smart chip provides a convenient, secure and tamper-resistant (i.e., not accessible by the user) and nonvolatile storage facility for data. Accordingly, in one embodiment, the collective data used to ensure uniqueness is stored on the smart chip 130. Details for such embodiments are described in U.S. patent application Ser. No. 10/422,663, entitled “METHOD TO ENSURE A UNIQUE MACHINE SERIAL NUMBER”, which is herein incorporated by reference in its entirety. These data stored on the smart chip 130 may then be used to validate the code 114.

The enablement code 114 may be input to a capacity manager 120 via a user interface 118 (which may be displayable via the browser 110). Alternatively, the code 114 is input directly by the provider computer 102 via a communication link (e.g., a network or modern connection). In still another embodiment, the code 114 is input to the capacity manager 120 via an application or some other program or routine.

In one embodiment, the capacity manager 120 is at least a component of the Capacity on Demand function provided on machines from International Business Machines, Inc. One such machine is the eServer iSeries® computer. By way of illustration only, the capacity manager 120 and user interface 118 are shown as components of an operating system 122. Examples of the operating system 122 include IBM OS/400®, AIX®, UNIX, Microsoft Windows®, and the like. However, the illustrated representation is merely one example of a particular software architecture, and not limiting of the invention. OS/400® and AIX®, are registered trademarks of International Business Machines, Inc., and Microsoft Windows® is a registered trademark of Microsoft, Inc.

In one embodiment, a code verification algorithm 124 is invoked to verify the enablement code 114. As noted above, the code 114 is preferably specific to a particular machine. Accordingly, the verification algorithm 124 determines whether the code 114 is configured for the particular machine for which the capacity manager 120 has responsibility and controls resource access. In this regard, it is contemplated that the capacity manager 120 may have resource access responsibility for a plurality of computers (i.e., a network). More typically, however, the capacity manager 120 manages only the resources of the machine on which it resides. In this case, the verification algorithm 124 determines whether the code 114 is configured for the particular machine on which the capacity manager 120 resides. In one embodiment, the verification algorithm 124 accesses validation data stored in the smart chip 130 disposed on the capacity card 129.

Additional embodiments for generation and validation of enablement codes are described in U.S. patent application Ser. No. 10/406,652, entitled “METHOD TO PROVIDE ON-DEMAND RESOURCE ACCESS” and in U.S. patent application Ser. No. ______ (Atty docket number ROC920030175), entitled “METHOD TO DISABLE ON/OFF CAPACITY ON DEMAND”, which are herein incorporated by reference in their entirety. However, it is understood that the described embodiments are merely illustrative and persons skilled in the art will recognize other embodiments.

If an enablement code 114 is validated, the capacity manager 120 then enables selected resources 128, e.g., according to data contained in the enablement code 114. In particular, a resource allocator 126 (a function of the capacity manager 120) is invoked to enable, or “unlock”, the selected resources. Enabling the resources 128 may be implemented by the provision of capacity on demand hardware, illustratively in the form of the capacity on demand card(s) 129. Each card 129 may be specific to a particular hardware type, e.g., processors, memory, etc. Alternatively, a single card may be used to enable multiple resource types. In one aspect, the capacity on demand card 129 includes at least one smart chip 130 used to store capacity on demand information in a secure (i.e., not accessible by the user) and nonvolatile manner. In one embodiment, the information stored in the capacity on demand card 129 (e.g., in the smart chip 130) includes state information 132 for the computer 104. As such, the card provides a master copy of such information that may be used to recover from a power failure situation or other catastrophic failures.

In one embodiment, “enabling” or “unlocking” resources by the resource allocator 126 operates to place the resources into service (i.e., to perform their designated functions such as processing or storing, depending upon the resource). In another embodiment, enabling the resources does not place the resources into service, but merely makes the resources available for request, e.g., by a user/function. That is, enabling the resources unlocks the resources so that they can be assigned to a function, but does not automatically give control of the resources to any particular function or operating system(s) on the computer. In one embodiment, the functions requesting/requiring the use of the on-demand resources are any variety of persistent system functions 134. One such system function is logical partitioning. Logical partitioning refers to the ability to make a system run as if it were two or more independent systems. Each logical partition represents a division of resources in the system and operates as an independent logical system. Each partition is logical because the division of resources may be physical or virtual. An example of logical partitions is the partitioning of a multiprocessor computer system into multiple independent servers, each with its own processors, main storage, and I/O devices. One of multiple different operating systems, such as AIX®, LINUX, and others can be running in each partition. It is noted that the system functions 134 are shown as part of the operating system 122 merely for purposes of illustration. In other environments, one or more system functions may be architecturally separate from the operating system 122.

In one embodiment, the on-demand resources being used by the system function(s) 134 are recorded as part of the state information 132 stored in the smart chip 130. In this way, the capacity manager 120 can identify a compliant or incompliant configuration, with respect to the system function(s) 134 during boot (e.g., following a system crash or power failure).

Generally, the resources enabled according the enablement code 114 may be any variety of resources in a computerized apparatus. Such apparatus include any type of computer, computer system, or other programmable electronic device including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention. A computer may include any electronic device having at least one processor, and may be a standalone device or part of a network.

As noted above, the capacity card 129 provides persistent storage for the state information 132, which describes the state of the computer 104. If the state information 132 is corrupted or removed (e.g., due to a card failure or upgrade), the capacity manager 120 would normally invoke an enforcement policy 136 to, e.g., prevent the system functions 134 from using the on-demand resources 128. However, an embodiment of the present invention provides a grace period routine 138 which makes the on-demand resources 128 available for a defined period of time after the necessary state information 132 has been lost. Expiration of the grace period may be determined with reference to a timer 140.

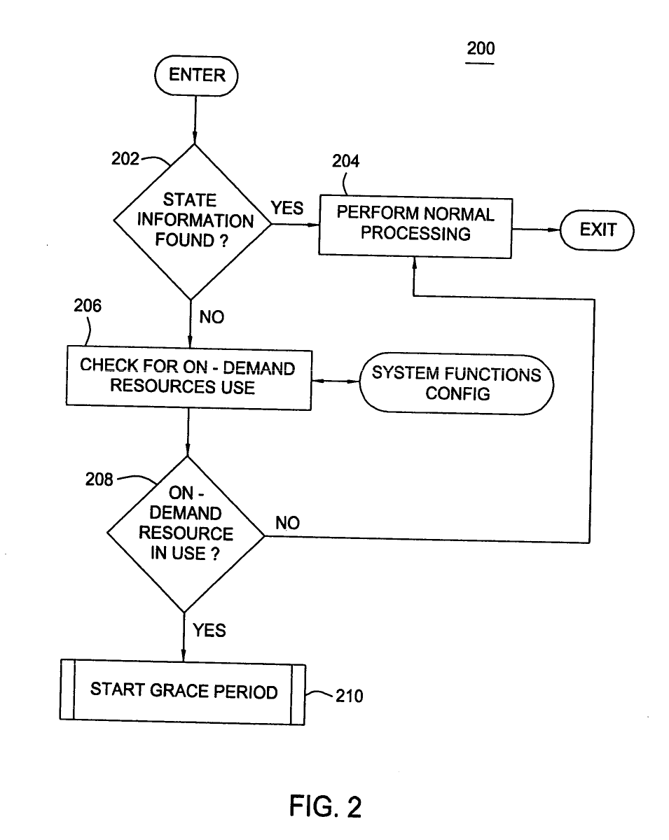

FIGS. 2, 3 and 4 show flowcharts of one embodiment implementing a grace period. Referring first to FIG. 2, a method 200 is shown illustrating one possible series of events for entering the grace period routine 138. In one embodiment, the method 200 is implemented by the capacity manager 120. The method 200 may be entered, for example, during reboot following a power failure or system crash. Initially, a check is performed (at block 202) to determine whether state information for the system can be found, e.g., the state information 132 in the smart chip 130, as shown in FIG. 1. If so, then processing may be performed as normal (i.e., according to prior art) or in any other suitable manner (block 204). If, however, no state information is found, then a check is performed (at block 206) to determine whether on-demand resources are being used. That is, the configuration of the system function(s) 134 is checked. It is noted that this step is preferably called after a known point during boot at which system function(s) 134 claims on-demand resources. If necessary, this check may also be called multiple times. If the system function(s) 134 is not presently using on-demand resources (determined at block 208), then the system is in a valid/compliant configuration and processing continues as normal (block 204). However, if the system function(s) 134 is presently using on-demand resources (or has claimed on-demand resources for future use), then the system is in an invalid/incompliant configuration, and a grace period is initiated (block 210). That is, the grace period routine 138 is called.

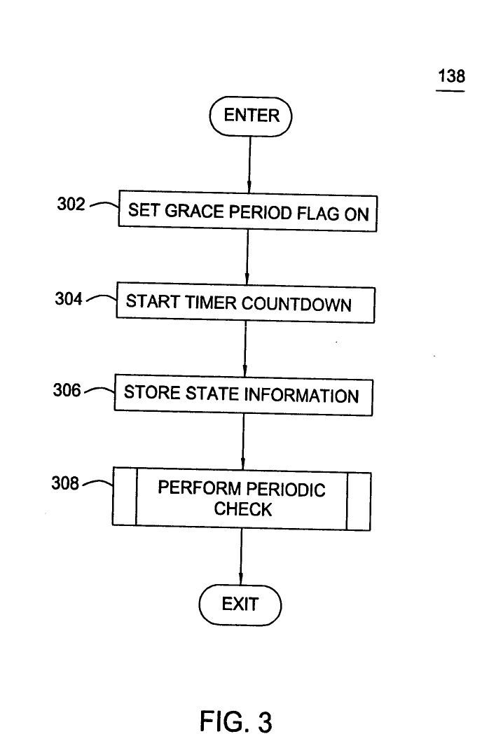

One embodiment of the grace period routine 138 is described with reference to FIG. 3. Upon entering the routine 138, a grace period flag is set to ON (block 302). A timer countdown is then initiated (block 304), and the current state of the system is stored to the smart chip 130 (block 306).

The routine 138 then enters a routine (block 308) which performs a periodic check to determine whether the grace period has expired or whether some other event has occurred to terminate the grace period. Although, implemented as a loop in the present embodiment, the routine entered at block 308 may also be event driven (or implemented in any other suitable manner).

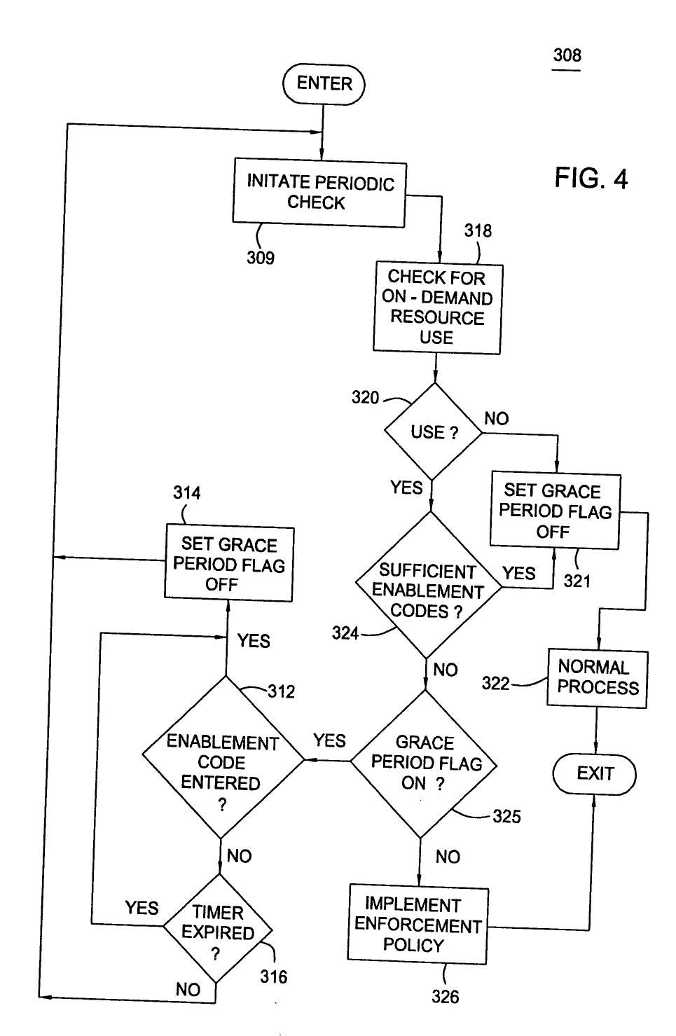

One embodiment of the periodic check routine entered at block 308 is described with reference to FIG. 4. Upon entering the routine, a periodic loop check is initiated (block 309) that checks for on-demand resources usage (or, more generally, a claim to the resources) by the system function(s) 134 (block 318). If the system function(s) 134 is not using the resources, i.e., the system function(s) 134 has returned the on-demand resources, (determined at block 320), the grace period flag is reset (block 321) and processing proceeds as normal (block 322), exiting the period check loop. If, however, the system function(s) 134 has claimed (or is currently using) on-demand resources, the routine 138 determines whether sufficient enablement codes have been input to the system (block 324). That is, the state information 132 stored in the smart chip 130 is checked to determine whether the configuration of the system function(s) 134 is compliant or incompliant, on the basis of input enablement codes. If sufficient enablement codes have been input, i.e., the system is compliant, the grace period flag is reset (block 321) and processing proceeds as normal (block 322), exiting the period check loop routine 308. Otherwise, the grace period flag is checked (block 325), and if OFF, the enforcement policy 136 is implemented (block 326).

Alternatively, if the routine 138 determines that on-demand resources are claimed or used (block 320), insufficient enablement codes are entered (block 324) and the grace period flag is still set to ON (block 325), the routine 138 determines whether any enablement codes have been entered (block 312). That is, since the last execution of the periodic check loop, a user may have entered enablement codes to enable part or all of the available on-demand resources on the system. If any enablement code has been entered, the grace period flag is set to OFF (block 314). For purposes of the present embodiment, it is contemplated that the grace period flag is set to OFF, even if the quantity of resources enabled is not sufficient to place the system into a compliant state (i.e., the system functions 134 require more on-demand resources that are enabled). However, in an alternative embodiment, the grace period flag is not set to OFF, if the quantity of resources enabled is insufficient to place the system into a compliant state. That is, the grace period timer continues counting down until expiring or sufficient resources have been properly enabled.

Returning to block 312, if no enablement code has been entered, the routine 138 determines whether the grace period timer has expired (at block 316). If so, the grace period flag is set to OFF (block 314). Otherwise (i.e., if the timer has not expired), the periodic loop check is complete and processing returns to block 309 to repeat the periodic loop check at an appropriate time interval.

It is noted that, in order to place the system into a compliant state, the system function(s) 134 may have returned some, or all, of on-demand resources it was previously using during the grace period. For example, where an enablement code(s) is entered during the grace period that does not enable all of the on-demand resources currently being used by the system function(s), the system function(s) 134 may return the difference (i.e., that portion of the on-demand resources which it cannot validly use based on the enablement code(s)). It is also contemplated that this event (i.e., returning resources by the system function(s) 134) causes the grace period flag to be set to OFF on the next iteration of the periodic check (block 308). Persons skilled in the art will recognize other embodiments.

Accordingly, embodiments are provided for using on-demand resources for a period of time during which the system configuration is incompliant with respect to those resources. These embodiments provide numerous advantages over the prior art, as will be evident to the skilled in the art. However, although embodiments of the invention may achieve advantages over other possible solutions, whether or not a particular advantage is achieved by a given embodiment is not limiting of the invention.

While the foregoing is directed to embodiments of the present invention, other and further embodiments of the invention may be devised without departing from the basic scope thereof, and the scope thereof is determined by the claims that follow.

1. A computer-implemented method for providing access to on-demand resources on a computerized apparatus, comprising:
receiving an enablement code;
validating the enablement code;
enabling an on-demand resource, if the validating is successful;
storing an enabled state of the on-demand resource;
allowing a function to use the enabled on-demand resource; and
in response to a change from the enabled state to a non-enabled state of the on-demand resource, initiating a grace period during which the function may continue to use the on-demand resource while in the non-enabled state.

2. The computer-implemented method of claim 1, wherein initiating the grace period is a system function not invoked by a user-input enablement code.

3. The computer-implemented method of claim 1, wherein the enabled state is described by information contained in a smart chip.

4. The computer-implemented method of claim 1, wherein enabling comprises unlocking the on-demand resource.

5. The computer-implemented method of claim 1, wherein validating comprises verifying that the enablement code is unique to the on-demand resource.

6. The computer-implemented method of claim 1, wherein the function is logical partitioning.

7. The computer-implemented method of claim 1, wherein the at least one on-demand resource is a processor.

8. The computer-implemented method of claim 1, wherein the at least one on-demand resource comprises one of memory and storage.

9. The computer-implemented method of claim 1, wherein initiating the grace period comprises initiating a countdown.

10. The computer-implemented method of claim 1, further comprising:
during the grace period, receiving, by the computerized apparatus, an enablement code which places the on-demand resource into the enabled state; and
terminating the grace period.

11. The computer-implemented method of claim 1, further comprising:
terminating the grace period; and then
preventing the function from further use of the on-demand resource.

12. The computer-implemented method of claim 1, wherein storing the enabled state comprises storing the enabled state to a persistent storage device.

13. The computer-implemented method of claim 12, wherein the change from the enabled state to the non-enabled state is caused by removal of the persistent storage device.

14. A computer-implemented method for providing access to on-demand resources on a computerized apparatus, comprising:
enabling an on-demand resource;
allowing a function to use the on-demand resource;
disabling the on-demand resource; and
allowing the function to continue using the on-demand resource for a limited period of time after disabling the on-demand resource in order to give a user of the computerized apparatus an opportunity to request and receive an enablement code configured to enable the on-demand resource.

15. The computer-implemented method of claim 14, wherein disabling the on-demand resource is caused by removal of a persistent storage device containing state information for the on-demand resource.

16. The computer-implemented method of claim 14, wherein allowing the function to continue using the on-demand resource for a limited period of time is a system function not invoked by a user-input enablement code.

17. The computer-implemented method of claim 14, further comprising preventing the function from using the on-demand resource after expiration of the limited period of time.

18. The computer-implemented method of claim 14, wherein enabling comprises unlocking the on-demand resource.

19. The computer-implemented method of claim 14, wherein the enabled state is described by information contained in a smart chip.

20. A computer-implemented method for providing access to an on-demand resource on a logically partitioned computerized apparatus, comprising:
claiming, by a logical partition function, the use of the on-demand resource;
recording the logical partition function's use of the on-demand resource as state information;
changing the state information, whereby use of the on-demand resource by the logical partition function is made incompliant with respect to the state information; and
initiating a grace period during which the logical partition function is allowed to continue using the on-demand resource for a limited period of time after changing the state information.

21. The computer-implemented method of claim, 20 wherein changing the state information is caused by removal of a persistent storage device containing the state information for the on-demand resource.

22. The computer-implemented method of claim 20, wherein initiating the grace period comprises initiating a countdown timer.

23. The computer-implemented method of claim 20, further comprising terminating the grace period if the system is returned to a compliant state.

24. The computer-implemented method of claim 20, wherein allowing the function to continue using the on-demand resource for a limited period of time is a system function not invoked by a user-input enablement code.

25. The computer-implemented method of claim 20, further comprising preventing the function from using the on-demand resource after expiration of the grace period.

26. The computer-implemented method of claim 20, wherein the state information further comprises enablement code information indicating whether or not the use of the on-demand resource is authorized.

27. The computer-implemented method of claim 20, wherein the state information is contained in a smart chip.

28. A computer readable medium containing a program which, when executed, performs an operation for providing access to an on-demand resource on a computerized apparatus, the operation comprising:
recording a compliant state of the computerized apparatus, with respect to the on-demand resource, in which a system function uses the on-demand resource with authorization;
determining an incompliant state, with respect to the on-demand resource, in which the system function uses the on-demand resource without authorization; and
initiating a grace period during which the system function may continue to use the on-demand resource while in the incompliant state.

29. The computer readable medium of claim 28, wherein the system function is a partition manager.

30. The computer readable medium of claim 28, wherein initiating the grace period comprises initiating a countdown counter.

31. The computer readable medium of claim 28, further comprising preventing the system function from using the on-demand resource after expiration of the grace period.

32. The computer readable medium of claim 28, further comprising terminating the grace period if the system is returned to a compliant state.

33. The computer readable medium of claim 28, wherein recording the compliant state comprises writing to a smart chip.

34. The computer readable medium of claim 28, wherein determining the incompliant state comprises reading a smart chip.

35. The computer-implemented method of claim 28, wherein the on-demand resource is one of a processor, memory and storage.

36. A computerized apparatus, comprising:
on-demand resources configured to be claimed for use by a function; and
a capacity manager configured to:
enable the on-demand resources for use by the function, wherein the computerized apparatus is in a compliant state when the function only claims usage of the enabled on-demand resources and does not claim any disabled on-demand resources; and
initiate a grace period during which the function may continue to use the on-demand resources while in the incompliant state for a defined period of time.

37. The computerized apparatus of claim 36, wherein the capacity manager is further configured to implement an enforcement policy restricting the use of the on-demand resources after expiration of the grace period.

38. The computerized apparatus of claim 36, wherein the function is a partition manager for managing a plurality of logical partitions.

39. The computerized apparatus of claim 36, further comprising a persistent storage device to store state information used to determine whether the computerized apparatus is in the compliant state or the incompliant state with respect to the function's claim to usage of the on-demand resources.

40. The computerized apparatus of claim 36, wherein the on-demand resources comprise at least one of a processor, memory and storage.

41. The computerized apparatus of claim 36, wherein the capacity manager is configured to enable the on-demand resources by unlocking the on-demand resources and making the on-demand resources available for use upon request.

42. The computerized apparatus of claim 36, wherein the capacity manager is further configured to receive enablement codes configured to enable the on-demand resources.

43. The computerized apparatus of claim 42, wherein the capacity manager is configured to determine whether each enablement code is valid by determining whether the enablement code is unique to the computerized apparatus.
